(19) United States
(12) Patent Application Publication
(10) Pub. No.: US 2024/0193339 A1
(43) Pub. Date: Jun. 13, 2024

(54) METHOD OF ANALYZING ELECTROSTATIC DISCHARGE NETWORK USING COMMON RESISTANCE REMOVAL, SYSTEM PERFORMING THE SAME AND METHOD OF MANUFACTURING SEMICONDUCTOR DEVICE USING THE SAME

(71) Applicant: SAMSUNG ELECTRONICS CO., LTD., Suwon-si (KR)

(72) Inventors: Jordan Timothy Davis, Suwon-si (KR); Woojin Seo, Suwon-si (KR); Chanhee Jeon, Suwon-si (KR)

(21) Appl. No.: 18/532,496

(22) Filed: Dec. 7, 2023

(30) Foreign Application Priority Data
Dec. 12, 2022 (KR) 10-2022-0172459
Apr. 4, 2023 (KR) 10-2023-0044128

(51) Int. Cl. G06F 30/392; G06F 30/327; G06F 30/394

(52) U.S. Cl. CPC G06F 30/392; G06F 30/327; G06F 30/394; G06F 2115/06

(57) ABSTRACT

In an example method of analyzing an electrostatic discharge (ESD) network, input data characterizing a semiconductor device is received. The semiconductor device includes an input/output (I/O) pad, an ESD protection circuit, and at least one functional circuit. A common resistance of the ESD protection circuit is calculated based on the input data and using a plurality of resistances and at least one predetermined equation. The plurality of resistances are associated with the I/O pad, the ESD protection circuit, and the at least one functional circuit. A network analysis is performed on the semiconductor device by excluding the common resistance.

### CROSS-REFERENCE TO RELATED APPLICATIONS

This application claims priority under 35 USC § 119 to Korean Patent Application No. 10-2022-0172459, filed on Dec. 12, 2022, and to Korean Patent Application No. 10-2023-0044128, filed on Apr. 4, 2023, in the Korean Intellectual Property Office (KIPO), the contents of which are herein incorporated by reference in their entirety.

### BACKGROUND

Electrostatic discharge (ESD) is defined as the rapid, spontaneous transfer of electrostatic charge induced by a high electrostatic field. ESD may change the electrical characteristics of a semiconductor device, degrading or destroying it. An ESD protection circuit may be used to shunt the ESD current through the unpowered integrated circuit (IC) along the intended ESD protection path, while clamping the voltage at a safe level, without causing any IC functional performance degradation. An ESD protection mechanism should therefore have the ability to protect the circuit and the components to which it is connected.

To ensure a robust ESD protection design, ESD protection evaluation and verification can be done at every stage of an overall IC design flow. For example, the ESD verification may be performed using an electronic design automation (EDA). Various methods have been researched for the accurate, efficient, and fast verification.

### SUMMARY

The present disclosure relates to methods of accurately, rapidly, and efficiently analyzing an electrostatic discharge (ESD) network using common resistance removal, as well as systems performing the methods of analyzing the ESD network and methods of manufacturing a semiconductor device using the methods of analyzing the ESD network.

In some implementations, in a method of analyzing an electrostatic discharge (ESD) network, input data defining a semiconductor device is received. The semiconductor device includes an input/output (I/O) pad, an ESD protection circuit and at least one functional circuit. A common resistance of the ESD protection circuit is calculated using a plurality of resistances and at least one predetermined equation. The plurality of resistances are associated with the I/O pad, the ESD protection circuit and the at least one functional circuit. A network analysis is performed on the semiconductor device by excluding the common resistance.

In some implementations, a system of analyzing an electrostatic discharge (ESD) network includes a storage device and a processor. The storage device stores information including procedures. The processor accesses the storage device, and executes the procedures. The procedures comprise an analysis module configured to receive input data defining a semiconductor device including an input/output (I/O) pad, an ESD protection circuit and at least one functional circuit, calculate a common resistance of the ESD protection circuit using a plurality of resistances and at least one predetermined equation, and perform a network analysis on the semiconductor device by excluding the common resistance. The plurality of resistances are associated with the I/O pad, the ESD protection circuit and the at least one functional circuit.

In some implementations, in a method of analyzing an electrostatic discharge (ESD) network, input data defining a semiconductor device is received. The semiconductor device includes an input/output (I/O) pad, an ESD protection circuit and at least one functional circuit that are connected to each other by a first node. A first resistance, a second resistance and a third resistance associated with the I/O pad, the ESD protection circuit and the at least one functional circuit are obtained. A common resistance of the ESD protection circuit is calculated using the first resistance, the second resistance, the third resistance and at least one predetermined equation. A network analysis is performed on the semiconductor device by removing the common resistance from the semiconductor device, by performing a simulation on the semiconductor device from which the common resistance is removed, and by checking, based on a result of the simulation, whether a predetermined rule is violated. The ESD protection circuit includes a first diode, a second diode, a second resistor and a third resistor. The first diode and the second resistor are connected in series between a power supply voltage and the first node. The second diode and the third resistor are connected in series between the first node and a ground voltage. The first resistance corresponds to a resistance between the I/O pad and the first diode in the ESD protection circuit, the second resistance corresponds to a resistance between the I/O pad and the second diode in the ESD protection circuit, and the third resistance corresponds to a resistance between the first diode and the second diode in the ESD protection circuit. A first value is obtained by adding the first resistance and the second resistance, a second value is obtained by subtracting the third resistance from the first value, and the common resistance is obtained by dividing the second value by two.

In some implementations, in a method of manufacturing a semiconductor device, the semiconductor device including an input/output (I/O) pad, an electrostatic discharge (ESD) protection circuit and at least one functional circuit is designed. The semiconductor device is fabricated based on a result of designing the semiconductor device. When designing the semiconductor device, an ESD network of the semiconductor device is analyzed by receiving input data defining the semiconductor device, by calculating a common resistance of the ESD protection circuit using a plurality of resistances and at least one predetermined equation, and by performing a network analysis on the semiconductor device by excluding the common resistance, the plurality of resistances being associated with the I/O pad, the ESD protection circuit and the at least one functional circuit.

In the method of analyzing the ESD network, the system of analyzing the ESD network and the method of manufacturing the semiconductor device according to example implementations, the common resistance of the ESD protection circuit connected to the I/O pad may be calculated using the at least one predetermined equation, and the network analysis may be performed by excluding the calculated common resistance. The common resistance may be accurately and efficiently calculated by solving the system of equations from point-to-point resistances without additional simulation. In addition, the robust and simple solution that is applied to a variety of systems and/or tools that extract a parasitic resistance may be provided. Accordingly, the ESD network may be analyzed and verified accurately, quickly, and efficiently.

### BRIEF DESCRIPTION OF THE DRAWINGS

Illustrative, non-limiting example implementations will be more clearly understood from the following detailed description, taken in conjunction with the accompanying drawings.

FIG. 1 is a flowchart illustrating an example of a method of analyzing an electrostatic discharge (ESD) network.

FIG. 2 is a diagram for describing an example of a method of analyzing an ESD network.

FIGS. 3 and 4 are block diagrams illustrating an example of a system.

FIG. 5 is a flowchart illustrating an example of calculating a common resistance in FIG. 1.

FIG. 6 is a circuit diagram illustrating an example of a semiconductor device that is a target of a method of analyzing an ESD network.

FIG. 7 is a flowchart illustrating an example of performing a network analysis on a semiconductor device in FIG. 1.

FIGS. 8, 9A, 9B, 9C, 9D, 9E, and 9F are circuit diagrams illustrating examples of a semiconductor device that is a target of a method of analyzing an ESD network.

FIG. 10 is a flowchart illustrating an example of a method of designing a semiconductor device.

FIG. 11 is a flowchart illustrating an example of a method of manufacturing a semiconductor device.

### DETAILED DESCRIPTION

Various example implementations will be described more fully with reference to the accompanying drawings, in which implementations are shown. The present disclosure may, however, be embodied in many different forms and should not be construed as limited to the implementations set forth herein. Like reference numerals refer to like elements throughout this application.

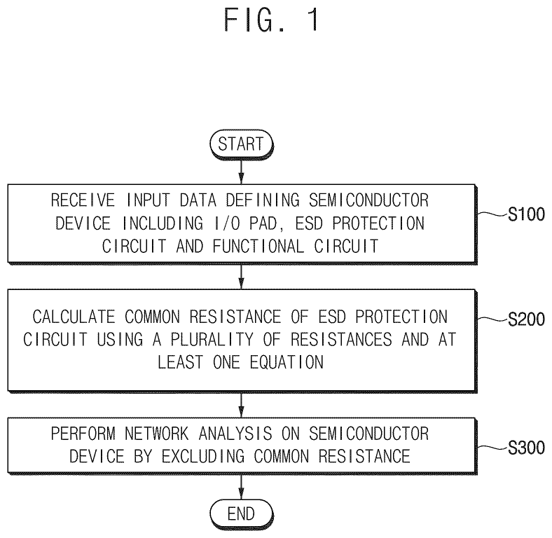

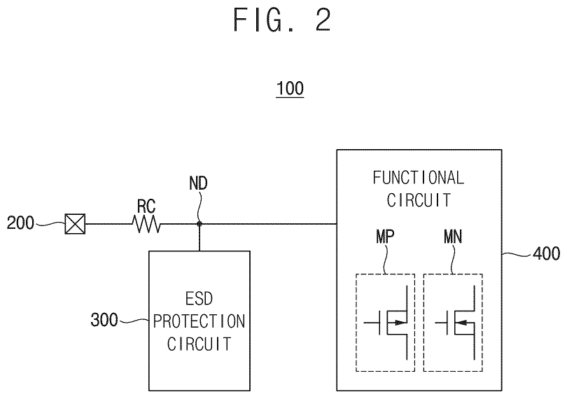

FIG. 1 is a flowchart illustrating an example of a method of analyzing an electrostatic discharge (ESD) network. FIG. 2 is a diagram for describing an example of a method of analyzing an ESD network.

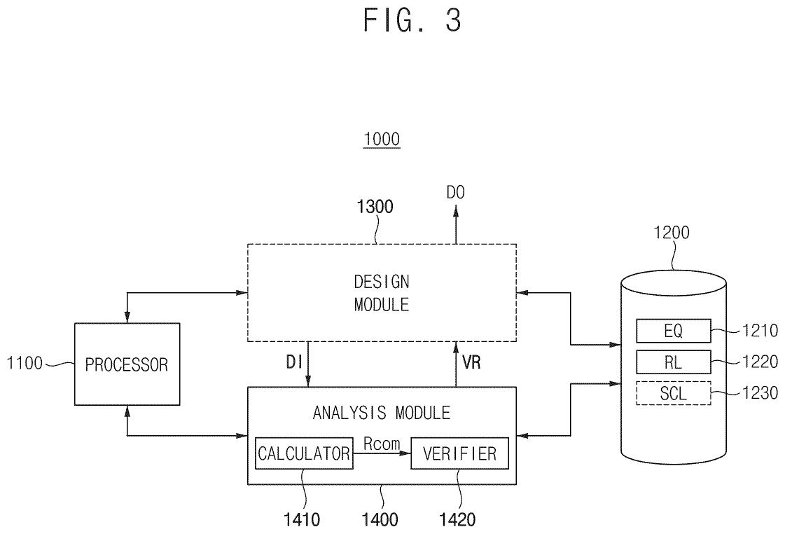

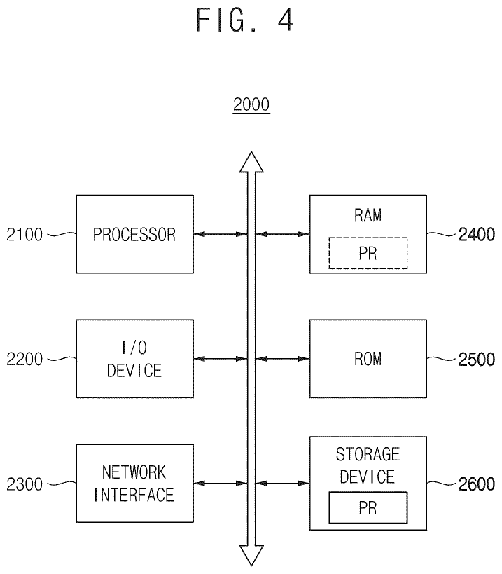

Referring to FIGS. 1 and 2, a method of analyzing an electrostatic discharge (ESD) network according to example implementations may be performed during a design process of a semiconductor device, and may be performed to check, verify and/or analyze functions, features and/or characteristics related to an ESD network formed by the semiconductor device. In addition, the method of analyzing the ESD network according to example implementations may be performed on a system and/or a tool for designing, verifying and/or analyzing the semiconductor device. For example, the system and/or the tool for designing, verifying and/or analyzing the semiconductor device may be a program including a plurality of instructions executed by a processor. The system and/or the tool will be described with reference to FIGS. 3 and 4.

In the method of analyzing the ESD network according to example implementations, input data defining the semiconductor device is received (operation S100). The semiconductor device includes an input/output (I/O) pad, an ESD protection circuit, and at least one functional circuit (or internal circuit). For example, the semiconductor device (or semiconductor integrated circuit) may be defined by a plurality of circuits and/or a plurality of cells, and may be designed using a library including information of the plurality of circuits and/or the plurality of cells.

In some example implementations, the input data may be data generated from an abstract form with respect to behavior of a semiconductor device. For example, the input data may be defined in a register transfer level (RTL) through synthesis. For example, the input data may be a bitstream or netlist that is generated by synthesizing a semiconductor device design defined by a hardware description language (HDL) such as VHSIC hardware description language (VHDL) or Verilog.

In some example implementations, the input data may be data for defining a layout of a semiconductor device. For example, the input data may include geometric information for defining a structure implemented as a semiconductor material, a conductor (e.g., metal), and an insulator. A layer of a semiconductor device design indicated by the input data may have a layout of circuits and/or cells and conducting wires used to connect a circuit and/or a cell to other circuits and/or cells, for example.

For example, as illustrated in FIG. 2, a semiconductor device 100 may include an I/O pad 200, an ESD protection circuit 300, and a functional circuit 400. The I/O pad 200, the ESD protection circuit 300 and the functional circuit 400 may be connected to each other through a node ND.

The I/O pad 200 may be a pad for inputting and/or outputting a signal. For example, a pad may be a contact pad or a contact pin, but example implementations are not limited thereto.

The ESD protection circuit 300 may be a circuit for preventing or reducing the impact of static electricity such as static electricity from triboelectric discharge or other static electricity occurring during the fabrication of and/or operation of the semiconductor device 100 such as plasma processing used during the fabrication of the semiconductor device 100. As a design rule of an integrated circuit is ever-decreasing and a degree of integration of the integrated circuit is ever-increasing, a concern on ESD increases. The semiconductor device 100 may include the ESD protection circuit 300 used to prevent or reduce the impact from electric charge abnormally incoming from the I/O pad 200 of the semiconductor device 100.

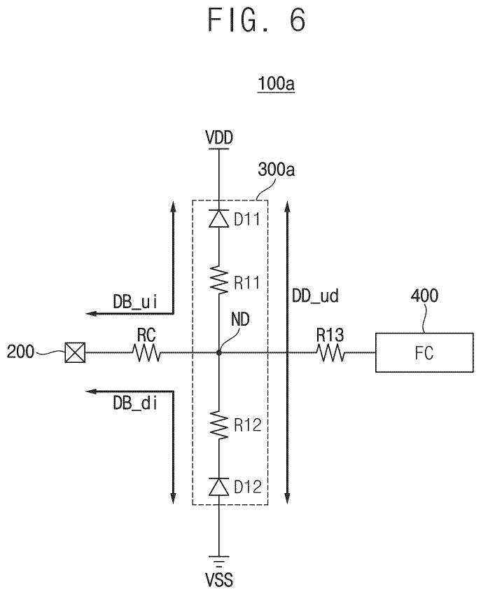

The ESD protection circuit 300 may limit a magnitude of a voltage of the node ND, to which the I/O pad 200 and the functional circuit 400 are connected, within a specific (or, alternatively, predetermined) range by providing a current path when a positive and/or negative over-voltage due to an ESD event is applied to the I/O pad 200. Therefore, the functional circuit 400 may be partially or fully protected. For example, the ESD protection circuit 300 may include at least one diode and at least one transistor. Detailed configurations of the ESD protection circuit 300 will be described with reference to FIGS. 6, 8, 9A, 9B, 9C, 9D, 9E and 9F.

The functional circuit 400 may be or may include a circuit for performing an operation of the semiconductor device 100. The functional circuit 400 may be referred to as a victim circuit because the functional circuit 400 is a target to protection. For example, the functional circuit 400 may include a plurality of blocks and/or a plurality of intellectual properties (IPs) that are divided or individualized by their own functions. For example, a block and/or an IP may represent a functional circuit block (or logic circuit block) predefined to be implemented in a semiconductor device, in some cases the function may be parameterized. For example, such functions may include analog or digital physical library functions, basic blocks such as counters or multiplexers, system level blocks, which are also known as cores or virtual components, and/or the like. For example, the plurality of blocks and/or the plurality of IPs may include at least one of a display control block, a file system block, a graphic processing unit (GPU) block, an image signal processing block, a multi-format codec block, and/or the like. For example, the functional circuit 400 may include at least one p-type metal oxide semiconductor (PMOS) transistor MP and at least one n-type metal oxide semiconductor (NMOS) transistor MN.

Although FIG. 2 illustrates that the semiconductor device 100 includes one I/O pad 200, one ESD protection circuit 300 and one functional circuit 400, example implementations are not limited thereto, and the number of I/O pads, the number of ESD protection circuits and the number of functional circuits included in the semiconductor device may be variously determined according to example implementations.

After the input data is received, a common resistance of the ESD protection circuit is calculated using a plurality of resistances and at least one predetermined equation (operation S200). The plurality of resistances are associated with or related to the I/O pad, the ESD protection circuit and the at least one functional circuit. For example, S200 may be performed based on the input data received in S100.

For example, the number and type of the plurality of resistances may be determined depending on a configuration of the ESD protection circuit, and for example, three or more resistances may be used for calculating the common resistance of the ESD protection circuit. For example, the plurality of resistances may be extracted by the system and/or the tool. For example, the common resistance of the ESD protection circuit may be calculated by solving a system of equations (or a set of equations) based on the plurality of resistances, or by substituting the plurality of resistances into an equation obtained by the system of equations.

As illustrated in FIG. 2, a resistor RC may be formed between the I/O pad 200 and the node ND, and a resistance of the resistor RC may represent or correspond to the common resistance. The common resistance may be an interconnect resistance that exists in both an ESD path by the ESD protection circuit 300 and a circuit path (or victim path) by the functional circuit 400. The common resistance may be referred to as an ESD path resistance, a parasitic resistance, or the like.

After the common resistance of the ESD protection circuit is calculated, a network analysis is performed on the semiconductor device by excluding (or except for) the common resistance (operation S300). For example, the network analysis may be performed on the ESD network formed by the semiconductor device. For example, S300 may be performed based on the input data received in S100 and the common resistance obtained in S200.

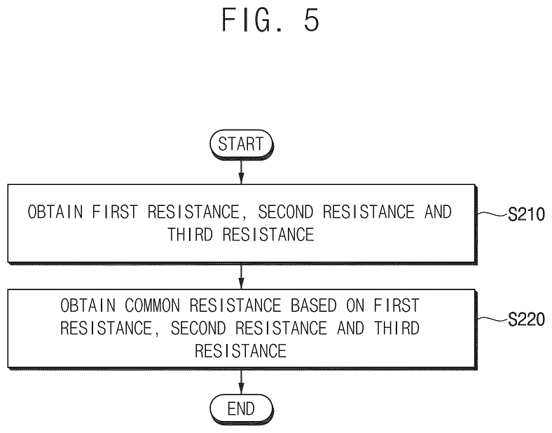

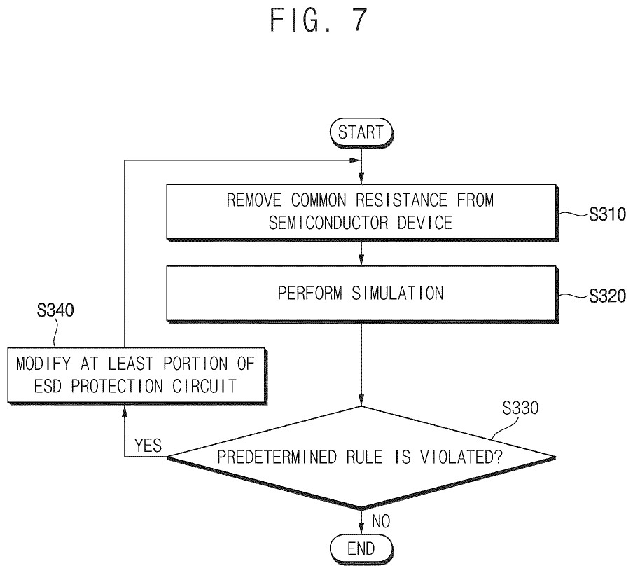

Detailed operations in S200 will be described with reference to FIG. 5, and detailed operations in S300 will be described with reference to FIG. 7.

To analyze an ESD network, it is necessary to extract a parasitic resistance of an ESD path and remove the parasitic resistance. Such the parasitic resistance may commonly exist in a path by a functional circuit (or a victim circuit) as well as the ESD path, and may be referred to as a common resistance. Such common resistance may not play a significant role with respect to an ESD current, and may be unnecessary for an analysis and/or interpretation of the ESD network. In addition, if the ESD network including the common resistance is analyzed, the accuracy of the analysis may be degraded or reduced. Conventionally, there was no method for accurately calculating the common resistance.

In the method of analyzing the ESD network according to example implementations, the common resistance of the ESD protection circuit 300 connected to the I/O pad 200 may be calculated using the at least one predetermined equation, and the network analysis may be performed by excluding the calculated common resistance. The common resistance may be accurately and efficiently calculated by solving the system of equations from point-to-point resistances without additional simulation. In addition, the robust and simple solution that is applied to a variety of systems and/or tools that extract a parasitic resistance may be provided. Accordingly, the ESD network may be analyzed and verified accurately, quickly, and efficiently.

FIGS. 3 and 4 are block diagrams illustrating an example of a system.

Referring to FIG. 3, a system 1000 includes a processor 1100, a storage device 1200 and an analysis module (or a verification module) 1400. The system 1000 may further include a design module 1300.

Herein, the term “module” may indicate, but is not limited to, a software and/or hardware component, such as a field programmable gate array (FPGA) or an application specific integrated circuit (ASIC), which performs certain tasks. A “module” may be configured to reside in a tangible addressable storage medium and be configured to execute on one or more processors. For example, a “module” may include components such as software components, object-oriented software components, class components and task components, and processes, functions, Routines, segments of program code, drivers, firmware, microcode, circuitry, data, databases, data structures, tables, arrays, and variables. A “module” may be divided into a plurality of “modules” that perform detailed functions.

In some example implementations, the system 1000 may be a computing system. In some example implementations, the system 1000 may be provided as a dedicated system for the method of analyzing the ESD network, and may be referred to as an ESD network analysis system. In some example implementations, the system 1000 may be provided as a dedicated system for a method of designing a semiconductor device using the method of analyzing the ESD network, and may be referred to as a semiconductor design system. For example, the system 1000 may include various design programs, analysis programs, verification programs and/or simulation programs.

The processor 1100 may control an operation of the system 1000, and may be utilized when the analysis module 1400 and/or the design module 1300 perform computations or calculations. For example, the processor 1100 may include a microprocessor, an application processor (AP), a central processing unit (CPU), a digital signal processor (DSP), a graphic processing unit (GPU), and/or the like. Although FIG. 3 illustrates that the system 1000 includes one processor 1100, example implementations are not limited thereto. For example, the system 1000 may include a plurality of processors. In addition, the processor 1100 may include cache memories to increase computation capacity.

The storage device 1200 may store data used for the operation of the system 1000 and operations of the analysis module 1400 and/or the design module 1300. For example, the storage device 1200 may store equations (EQ) (or data related to the equations) 1210, and design/verification rules (RL) (or data related to the design/verification rules) 1220. For example, the storage device 1200 may further store a standard cell library (SCL) 1230. The equations 1210 may be provided from the storage device 1200 to the analysis module 1400, the design/verification rules 1220 may be provided from the storage device 1200 to the analysis module 1400 and/or the design module 1300, and the standard cell library 1230 may be provided from the storage device 1200 to the design module 1300. Although not illustrated in detail, the storage device 1200 may additionally store sample data, simulation data, real data, and various other data. The real data may also be referred to herein as actual data or measured data from the manufactured semiconductor device and/or manufacturing process.

In some example implementations, the storage device (or storage medium) 1200 may include any non-transitory computer-readable storage medium used to provide commands and/or data to a computer. For example, the non-transitory computer-readable storage medium may include a volatile memory such as a static random access memory (SRAM), a dynamic random access memory (DRAM), or the like, and a nonvolatile memory such as a flash memory, a magnetic random access memory (MRAM), a phase-change random access memory (PRAM), a resistive random access memory (RRAM), or the like. The non-transitory computer-readable storage medium may be inserted into the computer, may be integrated in the computer, or may be coupled to the computer through a communication medium such as a network and/or a wireless link.

The analysis module 1400 may perform, using the processor 1100, a network analysis on a semiconductor device, which includes an I/O pad, an ESD protection circuit and at least one functional circuit, based on input data DI defining the semiconductor device, and may generate result data VR including a result of the network analysis.

The analysis module 1400 may include a calculator 1410 and a verifier 1420. The analysis module 1400 may perform the method of analyzing the ESD network according to example implementations described with reference to FIG. 1.

For example, the calculator 1410 and the verifier 1420 may receive the input data DI. The calculator 1410 may calculate a common resistance Rcom of the ESD protection circuit using a plurality of resistances and the equations 1210. The plurality of resistances may be associated with the I/O pad, the ESD protection circuit and the at least one functional circuit. The verifier 1420 may perform the network analysis on the semiconductor device by excluding the common resistance Rcom using the design/verification rules 1220, and may generate the result data VR. In other words, the calculator 1410 may perform operations S100 and S200 in FIG. 1, and the verifier 1420 may perform operations S100 and S300 in FIG. 1.

In some example implementations, when the system 1000 includes both the design module 1300 and the analysis module 1400, the input data DI may be provided from the design module 1300, and the result data VR may be provided to the design module 1300. In some example implementations, when the system 1000 includes only the analysis module 1400, the input data DI may be provided from an outside (e.g., an external design system), and the result data VR may be provided to the outside.

The design module 1300 may generate the input data DI to define the semiconductor device. For example, the design module 1300 may perform at least one of a behavior level design, an RTL design, a gate level design, and a layout level design. When the design of the semiconductor device is successfully completed, the design module 1300 may generate output data DO defining the semiconductor device.

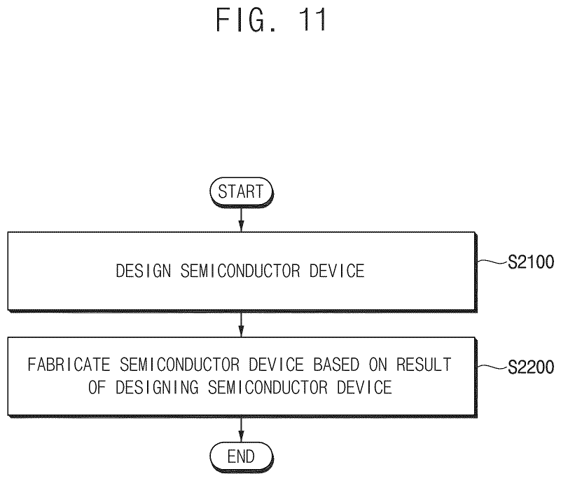

In some example implementations, the design module 1300 and the analysis module 1400 may perform a method of designing a semiconductor device, which will be described with reference to FIG. 10.

In some example implementations, the design module 1300 and the analysis module 1400 may be implemented as instructions or program code that may be executed by the processor 1100. For example, the instructions or program code of the calculator 1410 and the verifier 1420 that are included in the analysis module 1400 may be stored in computer readable medium. For example, the processor 1100 may load the instructions or program code to a working memory (e.g., a DRAM, etc.).

In some example implementations, the processor 1100 may be manufactured to execute (e.g., efficiently execute) instructions or program code included in the design module 1300 and the analysis module 1400. For example, the processor 1100 may execute (e.g., efficiently execute) the instructions or program code of the calculator 1410 and the verifier 1420 that are included in the analysis module 1400. For example, the processor 1100 may receive information corresponding to the calculator 1410 and the verifier 1420 to operate the calculator 1410 and the verifier 1420.

In some example implementations, the design module 1300 and the analysis module 1400 may be implemented as a single integrated module. In other example implementations, the design module 1300 and the analysis module 1400 may be implemented as separate and different modules.

The design module 1300 and/or the analysis module 1400 may be implemented in software, but example implementations are not limited thereto. When both the design module 1300 and the analysis module 1400 are implemented in software, the design module 1300 and the analysis module 1400 may be stored in the form of code in the storage device 1200, or may be stored in the form of code in another storage device separate from the storage device 1200.

Referring to FIG. 4, a system 2000 includes a processor 2100, an input/output (I/O) device 2200, a network interface 2300, a random access memory (RAM) 2400, a read only memory (ROM) 2500 and a storage device 2600. FIG. 4 illustrates an example where both the design module 1300 and the analysis module 1400 in FIG. 3 are implemented in software.

The system 2000 may be a computing system. For example, the computing system may be a fixed computing system such as a desktop computer, a workstation, or a server, or may be a portable computing system such as a laptop computer.

The processor 2100 may be substantially the same as the processor 1100 in FIG. 3. For example, the processor 2100 may include a core or a processor core for executing an arbitrary instruction set (for example, intel architecture-32 (IA-32), 64-bit extension IA-32, x86-64, PowerPC, Sparc, MIPS, ARM, IA-64, etc.). For example, the processor 2100 may access a memory (e.g., the RAM 2400 or the ROM 2500) through a bus, and may execute instructions stored in the RAM 2400 or the ROM 2500. As illustrated in FIG. 4, the RAM 2400 may store a program PR corresponding to the design module 1300 and/or the analysis module 1400 in FIG. 3 or at least some elements of the program PR, and the program PR may allow the processor 2100 to perform operations for analyzing the ESD network (e.g., operations S100, S200 and S300 in FIG. 1) in the semiconductor designing phase and/or operations for designing the semiconductor device (e.g., operations S1100, S1200, S1300, S1400, S1500, S1600 and S1700 in FIG. 10).

In other words, the program PR may include a plurality of instructions and/or procedures executable by the processor 2100, and the plurality of instructions and/or procedures included in the program PR may allow the processor 2100 to perform the operations for analyzing the ESD network in the semiconductor designing phase and/or the operations for designing the semiconductor device according to example implementations. Each of the procedures may denote a series of instructions for performing a certain task. A procedure may be referred to as a function, a routine, a subroutine, or a subprogram. Each of the procedures may process data provided from the outside and/or data generated by another procedure.

In some example implementations, the RAM 2400 may include any volatile memory such as an SRAM, a DRAM, or the like.

The storage device 2600 may be substantially the same as the storage device 1200 in FIG. 3. For example, the storage device 2600 may store the program PR. The program PR or at least some elements of the program PR may be loaded from the storage device 2600 to the RAM 2400 before being executed by the processor 2100. The storage device 2600 may store a file written in a program language, and the program PR generated by a compiler or the like or at least some elements of the program PR may be loaded to the RAM 2400.

The storage device 2600 may store data, which is to be processed by the processor 2100, or data obtained through processing by the processor 2100. The processor 2100 may process the data stored in the storage device 2600 to generate new data, based on the program PR and may store the generated data in the storage device 2600.

In some example implementations, the storage device 2600 may be a solid state drive (SSD). In other example implementations, the storage device 2600 may be a universal flash storage (UFS), a multi-media card (MMC) or an embedded multi-media card (eMMC). Alternatively, the storage device 2600 may be one of a secure digital (SD) card, a micro SD card, a memory stick, a chip card, a universal serial bus (USB) card, a smart card, a compact flash (CF) card, or the like.

The I/O device 2200 may include an input device, such as a keyboard, a pointing device, or the like, and may include an output device such as a display device, a printer, or the like. For example, a user may trigger, through the I/O device 2200, execution of the program PR by the processor 2100 or may provide various inputs, and may check the output data DO and the result data VR in FIG. 3, an error message, and/or the like.

The network interface 2300 may provide access to a network outside the system 2000. For example, the network may include a plurality of computing systems and communication links, and the communication links may include wired links, optical links, wireless links, or arbitrary other type links. Various inputs may be provided to the system 2000 through the network interface 2300, and the output data DO in FIG. 3 may be provided to another computing system through the network interface 2300.

FIG. 5 is a flowchart illustrating an example of calculating a common resistance in FIG. 1.

Referring to FIGS. 1 and 5, when calculating the common resistance of the ESD protection circuit (operation S200), a first resistance, a second resistance and a third resistance may be obtained (operation S210), and the common resistance may be obtained based on the first resistance, the second resistance and the third resistance (operation S220). The first resistance and the second resistance may be associated with the I/O pad, and the third resistance may be associated with the ESD protection circuit. For example, a first value may be obtained by adding the first resistance and the second resistance, a second value may be obtained by subtracting the third resistance from the first value, and the common resistance may be obtained by dividing the second value by two. For example, the first resistance, the second resistance and the third resistance may be obtained by various commercial network analysis tools such as Integrated Circuit (IC) Validator Programmable Electrical Rules Checking (PERC) from Synopsis Inc., Caliber PERC from Siemens Inc., Pathfinder from Ansys Inc., etc.

FIG. 6 is a circuit diagram illustrating an example of a semiconductor device that is a target of a method of analyzing an ESD network. The descriptions repeated with FIG. 2 will be omitted.

Referring to FIG. 6, a semiconductor device 100a may include an I/O pad 200, an ESD protection circuit 300a and a functional circuit (FC) 400.

The ESD protection circuit 300a may be directly connected to a node ND. A resistor RC having a common resistance may be directly connected between the I/O pad 200 and the node ND. The functional circuit 400 may be connected to the node ND through a resistor R13.

The ESD protection circuit 300a may include diodes D11 and D12 and resistors R11 and R12. The diode D11 and the resistor R11 may be connected in series between a power supply voltage VDD and the node ND. The diode D12 and the resistor R12 may be connected in series between the node ND and a ground voltage VSS.

In a configuration of the semiconductor device 100a illustrated in FIG. 6, a first resistance DB_ui associated with the I/O pad 200 may correspond to a resistance between the I/O pad 200 and the diode D11 in the ESD protection circuit 300a, a second resistance DB_di associated with the I/O pad 200 may correspond to a resistance between the I/O pad 200 and the diode D12 in the ESD protection circuit 300a, and a third resistance DD_ud associated with the ESD protection circuit 300a may correspond to a resistance between the diode D11 and the diode D12 in the ESD protection circuit 300a. For example, the first resistance DB_ui may be the sum of the resistances of the resistors RC and R11, the second resistance DB_di may be the sum of the resistances of the resistors RC and R12, and the third resistance DD_ud may be the sum of the resistances of the resistors R11 and R12. Therefore, Equation 1, Equation 2 and Equation 3 may be obtained as follows:

Rcom+ui′=DB_ui [Equation 1]

Rcom+di′=DB_di [Equation 2]

ui′+di′=DD_ud [Equation 3]

In Equation 1, Equation 2 and Equation 3, Rcom denotes a resistance of the resistor RC, e.g., the common resistance, ui′ denotes a resistance of the resistor R11, and di′ denotes a resistance of the resistor R12. As described above, the first resistance DB_ui, the second resistance DB_di and the third resistance DD_ud may be obtained and/or extracted from any commercial network analysis tool. Equation 1, Equation 2, and Equation 3 may be a system of equations with three unknowns, and thus the common resistance Rcom may be obtained using Equation 4 by solving the system of equations.

Rcom=(DB_ui+DB_di−DD_ud)/2 [Equation 4]

FIG. 7 is a flowchart illustrating an example of performing a network analysis on a semiconductor device in FIG. 1.

Referring to FIGS. 1 and 7, when performing the network analysis on the semiconductor device by excluding the common resistance (operation S300), the common resistance may be removed (or eliminated) from the semiconductor device (operation S310), a simulation may be performed on the semiconductor device from which the common resistance is removed (operation S320), and it may be checked, based on a result of the simulation, whether a predetermined rule (e.g., the design/verification rules 1220 in FIG. 3) is violated.

When it is determined, based on the result of the simulation, that the predetermined rule is violated (operation S330: YES), at least a portion (or part) of the ESD protection circuit may be modified or changed (operation S340), and S310, S320 and S330 may be performed again based on the modified ESD protection circuit.

When it is determined, based on the result of the simulation, that the predetermined rule is satisfied (operation S330: NO), it may be determined that the network analysis has been successfully completed, and the process may be terminated.

For example, in the configuration of the semiconductor device 100a illustrated in FIG. 6, an ESD path resistance included or reported in the input data may correspond to the sum of resistances of the resistors RC and R11 or the sum of resistances of the resistors RC and R12. When the method of analyzing the ESD network according to example implementations is performed, the common resistance Rcom, which is obtained by Equation 4 in S200, may be removed from the semiconductor device 100a, and the network analysis may be performed to find a resistance from the I/O pad 200 to the ESD protection circuit 300a in the semiconductor device 100a from which the common resistance Rcom is removed. The resistance ui′ of the resistor R11 and/or the resistance di′ of the resistor R12, which are obtained as a result of the network analysis, may be compared with constraint values to determine whether the predetermined rule is violated. If the resistance ui′ and/or the resistance di′ is greater than the constraint values, the rule violation may be reported, and the resistance ui′ and/or the resistance di′ may be changed to satisfy the predetermined rule.

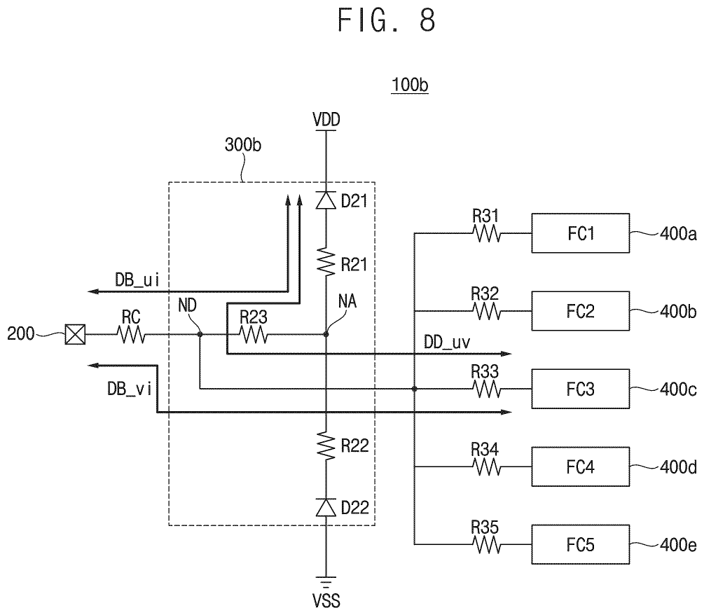

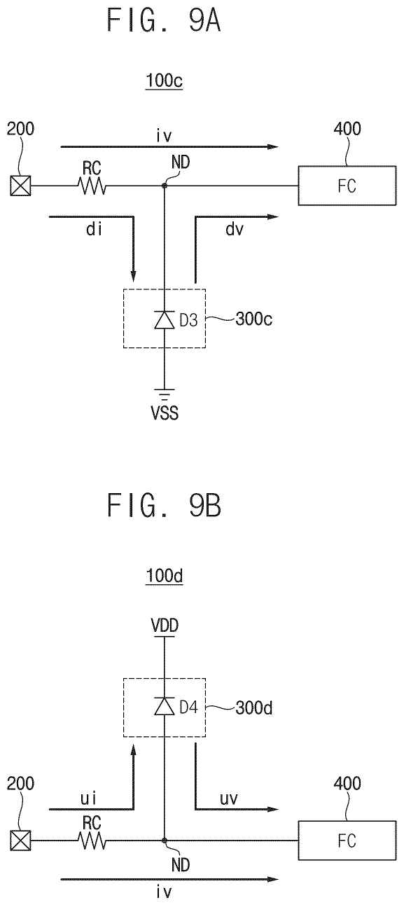

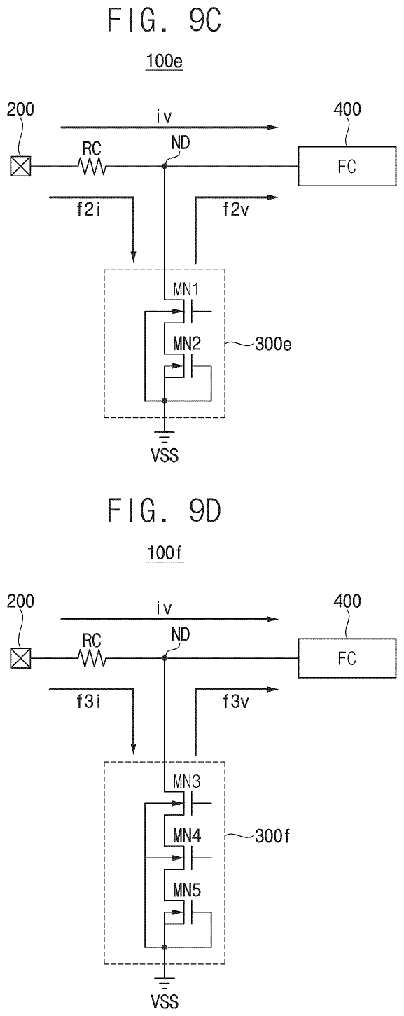

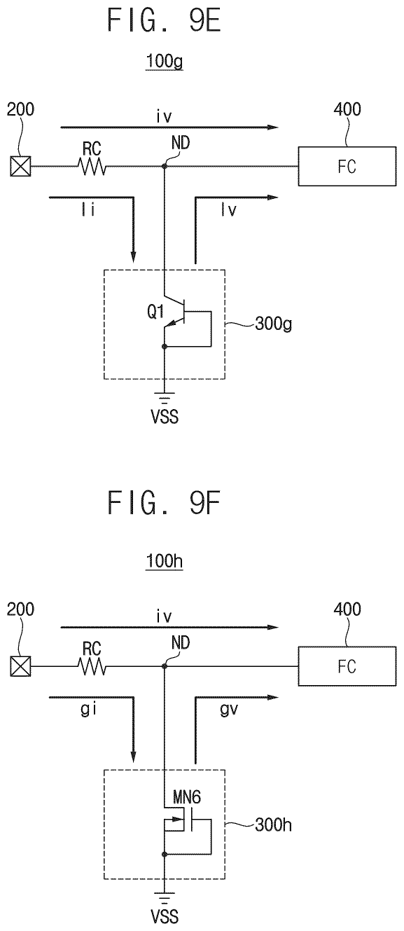

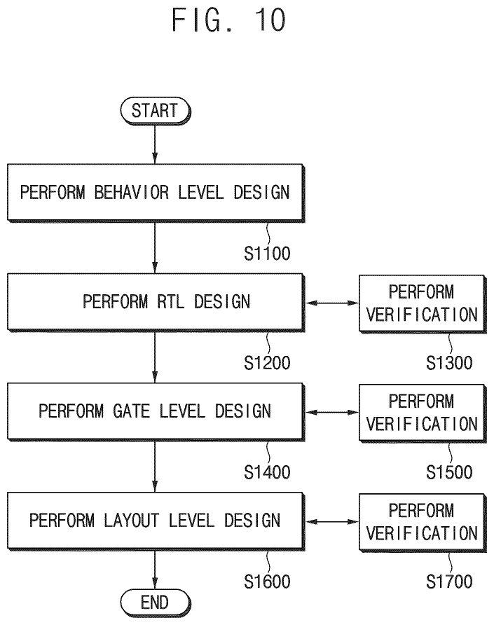

FIGS. 8, 9A, 9B, 9C, 9D, 9E, and 9F are circuit diagrams illustrating examples of a semiconductor device that is a target of a method of analyzing an ESD network. The descriptions repeated with FIG. 6 will be omitted.

Referring to FIG. 8, a semiconductor device 100b may include an I/O pad 200, an ESD protection circuit 300b, and a plurality of functional circuits (FC1, FC2, FC3, FC4 and FC5) 400a, 400b, 400c, 400d and 400e.

The ESD protection circuit 300b may be directly connected to a node ND and a node NA. A resistor RC having a common resistance may be directly connected between the I/O pad 200 and the node ND. The plurality of functional circuits 400a, 400b, 400c, 400d and 400e may be connected to the node ND through a plurality of resistors R31, R32, R33, R34 and R35, respectively.

The ESD protection circuit 300b may include diodes D21 and D22 and resistors R21, R22 and R23. The diode D21 and the resistor R21 may be connected in series between a power supply voltage VDD and the node NA. The diode D22 and the resistor R22 may be connected in series between the node NA and a ground voltage VSS. The resistor R23 may be connected between node ND and node NA.

In a configuration of the semiconductor device 100b illustrated in FIG. 8, an accurate common resistance may not be obtained if the common resistance Rcom is calculated similarly to that described with reference to FIG. 6. For example, if the common resistance Rcom is calculated based on Equation 4, e.g., using the third resistance DD_ud in FIG. 6, the sum of resistances of the resistors RC and R23 may be obtained rather than the resistance of the resistor RC. For example, the resistor R23 may be a resistor shared between the diodes D21 and D22 and may be a wire included in a lower metal layer in a manufacturing process.

Therefore, in the configuration of the semiconductor device 100b illustrated in FIG. 8, Equation 4 may not be used. It may be generalized for an arbitrary device other than the ESD protection circuit, the same analysis may be performed for all I/O related rules, and the common resistance Rcom may be obtained by Equation 5.

Rcom=(DB_ui+DB_vi−DD_uv)/2 [Equation 5]

For example, in the configuration of the semiconductor device 100b illustrated in FIG. 8, a first resistance DB_ui associated with the I/O pad 200 may correspond to a resistance between the I/O pad 200 and the diode D21 in the ESD protection circuit 300b, similar to the example of FIG. 6, a second resistance DB_vi associated with the I/O pad 200 may correspond to a resistance between the I/O pad 200 and the functional circuit 400c, and a third resistance DD_uv associated with the ESD protection circuit 300b may correspond to a resistance between the diode D21 in the ESD protection circuit 300b and the functional circuit 400c. As described above, the first resistance DB_ui, the second resistance DB_vi and the third resistance DD_uv may be obtained and/or extracted from any commercial network analysis tool. Thus, the common resistance Rcom may be obtained using Equation 5.

Although example implementations are described that the first resistance DB_ui represents the resistance between the I/O pad 200 and the diode D21 in the ESD protection circuit 300b, example implementations are not limited thereto. For example, DB_di, which corresponds to a resistance between the I/O pad 200 and the diode D22 in the ESD protection circuit 300b may be used as the first resistance. Similarly, although example implementations are described that the third resistance DD_uv represents the resistance between the diode D21 in the ESD protection circuit 300b and the functional circuit 400c, example implementations are not limited thereto. For example, DD_dv, which corresponds to a resistance between the diode D22 in the ESD protection circuit 300b and the functional circuit 400c may be used as the third resistance.

Referring to FIG. 9A, a semiconductor device 100c may include an I/O pad 200, an ESD protection circuit 300c and a functional circuit 400.

The ESD protection circuit 300c may include a diode D3. The diode D3 may be connected between a node ND and a ground voltage VSS. The ESD protection circuit 300c may limit a magnitude of a voltage of the node ND, to which the I/O pad 200 and the functional circuit 400 are connected, within a specific (or, alternatively, predetermined) range by providing a current path when a positive over-voltage due to an ESD event is applied to the I/O pad 200. Therefore, the functional circuit 400 may be partially or fully protected.

In a configuration of the semiconductor device 100c illustrated in FIG. 9A, a common resistance Rcom may be obtained by Equation 6.

Rcom=(di+iv−dv)/2 [Equation 6]

For example, in the configuration of the semiconductor device 100c illustrated in FIG. 9A, a first resistance di associated with the I/O pad 200 may correspond to a resistance between the I/O pad 200 and the diode D3 in the ESD protection circuit 300c, a second resistance value iv associated with the I/O pad 200 may correspond to a resistance between the I/O pad 200 and the functional circuit 400, and a third resistance dv associated with the ESD protection circuit 300c may correspond to a resistance between the diode D3 in the ESD protection circuit 300c and the functional circuit 400.

Referring to FIG. 9B, a semiconductor device 100d may include an I/O pad 200, an ESD protection circuit 300d and a functional circuit 400.

The ESD protection circuit 300d may include a diode D4. The diode D4 may be connected between a power supply voltage VDD and a node ND. The ESD protection circuit 300d may limit a magnitude of a voltage of the node ND, to which the I/O pad 200 and the functional circuit 400 are connected, within a predetermined range by providing a current path when a negative over-voltage due to an ESD event is applied to the I/O pad 200. Therefore, the functional circuit 400 may be protected.

In a configuration of the semiconductor device 100d illustrated in FIG. 9B, a common resistance Rcom may be obtained by Equation 7.

Rcom=(ui+iv−uv)/2 [Equation 7]

For example, in the configuration of the semiconductor device 100d illustrated in FIG. 9B, a first resistance ui associated with the I/O pad 200 may correspond to a resistance between the I/O pad 200 and the diode D4 in the ESD protection circuit 300d, a second resistance iv associated with the I/O pad 200 may correspond to a resistance between the I/O pad 200 and the functional circuit 400, and a third resistance uv associated with the ESD protection circuit 300d may correspond to a resistance between the diode D4 in the ESD protection circuit 300d and the functional circuit 400.

Referring to FIG. 9C, a semiconductor device 100e may include an I/O pad 200, an ESD protection circuit 300e and a functional circuit 400.

The ESD protection circuit 300e may include NMOS transistors MN1 and MN2. The NMOS transistors MN1 and MN2 may be connected in series between a node ND and a ground voltage VSS. A gate electrode of the NMOS transistor MN2 may be connected to the ground voltage VSS. FIG. 9C illustrates an example where a fail-safe 2-stack structure including two transistors MN1 and MN2 is implemented.

In a configuration of the semiconductor device 100e illustrated in FIG. 9C, a common resistance Rcom may be obtained by Equation 8.

Rcom=(f2i+iv−f2v)/2 [Equation 8]

For example, in the configuration of the semiconductor device 100e illustrated in FIG. 9C, a first resistance f2i associated with the I/O pad 200 may correspond to a resistance between the I/O pad 200 and the fail-safe 2-stack structure in the ESD protection circuit 300e, a second resistance iv associated with the I/O pad 200 may correspond to a resistance between the I/O pad 200 and the functional circuit 400, and a third resistance f2v associated with the ESD protection circuit 300e may correspond to a resistance between the fail-safe 2-stack structure in the ESD protection circuit 300e and the functional circuit 400.

Referring to FIG. 9D, a semiconductor device 100f may include an I/O pad 200, an ESD protection circuit 300f and a functional circuit 400.

The ESD protection circuit 300f may include NMOS transistors MN3, MN4 and MN5. The NMOS transistors MN3, MN4 and MN5 may be connected in series between a node ND and a ground voltage VSS. A gate electrode of the NMOS transistor MN5 may be connected to the ground voltage VSS. FIG. 9D illustrates an example where a fail-safe 3-stack structure including three transistors MN3, MN4 and MN5 is implemented.

In a configuration of the semiconductor device 100f illustrated in FIG. 9D, a common resistance Rcom may be obtained by Equation 9.

Rcom=(f3i+iv−f3v)/2 [Equation 9]

For example, in the configuration of the semiconductor device 100f illustrated in FIG. 9D, a first resistance f3i associated with the I/O pad 200 may correspond to a resistance between the I/O pad 200 and the fail-safe 3-stack structure in the ESD protection circuit 300f, a second resistance iv associated with the I/O pad 200 may correspond to a resistance between the I/O pad 200 and the functional circuit 400, and a third resistance f3v associated with the ESD protection circuit 300f may correspond to a resistance between the fail-safe 3-stack structure in the ESD protection circuit 300f and the functional circuit 400.

Referring to FIG. 9E, a semiconductor device 100g may include an I/O pad 200, an ESD protection circuit 300g and a functional circuit 400.

The ESD protection circuit 300g may include a bipolar junction transistor (BJT) element Q1. The BJT element Q1 may be connected between a node ND and a ground voltage VSS, and a base electrode of the BJT element Q1 may be connected to the ground voltage VSS. For example, the BJT element Q1 may be a lateral NPN BJT element.

In a configuration of the semiconductor device 100g illustrated in FIG. 9E, a common resistance Rcom may be obtained by Equation 10.

Rcom=(li+iv−lv)/2 [Equation 10]

For example, in the configuration of the semiconductor device 100g illustrated in FIG. 9E, a first resistance li associated with the I/O pad 200 may correspond to a resistance between the I/O pad 200 and the BJT element Q1 in the ESD protection circuit 300g, a second resistance iv associated with the I/O pad 200 may correspond to a resistance between the I/O pad 200 and the functional circuit 400, and a third resistance lv associated with the ESD protection circuit 300g may correspond to a resistance between the BJT element Q1 in the ESD protection circuit 300g and the functional circuit 400.

Referring to FIG. 9F, a semiconductor device 100h may include an I/O pad 200, an ESD protection circuit 300h and a functional circuit 400.

The ESD protection circuit 300h may include an NMOS transistor MN6. The NMOS transistor MN6 may be connected between a node ND and a ground voltage VSS, and a gate electrode of the NMOS transistor MN6 may be connected to the ground voltage VSS. For example, the NMOS transistor MN6 may be referred to as a gate-grounded NMOS transistor (GGNMOS) or a gate-grounded NMOSFET.

In a configuration of the semiconductor device 100h illustrated in FIG. 9F, a common resistance Rcom may be obtained by Equation 11.

Rcom=(gi+iv−gv)/2 [Equation 11]

For example, in the configuration of the semiconductor device 100h illustrated in FIG. 9F, a first resistance gi associated with the I/O pad 200 may correspond to a resistance between the I/O pad 200 and the NMOS transistor MN6 in the ESD protection circuit 300h, a second resistance iv associated with the I/O pad 200 may correspond to a resistance between the I/O pad 200 and the functional circuit 400, and a third resistance gv associated with the ESD protection circuit 300h may correspond to a resistance between the NMOS transistor MN6 in the ESD protection circuit 300h and the functional circuit 400.

The gate or base electrodes of the transistors MN2, MN5, Q1 and MN6 included in the ESD protection circuits 300e, 300f, 300g and 300h of FIGS. 9C, 9D, 9E and 9F may be connected to the ground voltage VSS, and thus each of the transistors MN2, MN5, Q1 and MN6 may operate as a diode. Therefore, it may be described that each of the ESD protection circuits 300e, 300f, 300g and 300h includes a diode. For example, it may be described that the diode included in each of the ESD protection circuits 300e and 300f includes two or more transistors. For example, it may be described that the diode included in each of the ESD protection circuits 300g and 300h includes one transistor.

Although example implementations are described based on various examples of the ESD protection circuits 300a, 300b, 300c, 300d, 300e, 300f, 300g and 300h, example implementations are not limited thereto.

FIG. 10 is a flowchart illustrating an example of a method of designing a semiconductor device.

Referring to FIG. 10, in a method of designing a semiconductor device according to example implementations, a behavior level design (or behavior level design process) corresponding to a functional design of the entire semiconductor device is performed first (operation S1100).

The behavior level design may be referred to as an architecture design or a high level design (or high level design process). The high level design may represent that a semiconductor device to be designed or as a target device is depicted at an algorithm level and is described in terms of high-level computer language (e.g., C language).

Next, an RTL design (or RTL design process) of the semiconductor device is performed (operation S1200), and a verification is performed on the semiconductor device on which the RTL design is completed (operation S1300).

Devices and/or circuits designed by the high level design process may be more concretely described by an RTL coding or simulation in S1200 and S1300. In addition, codes generated by the RTL coding may be converted into a netlist, and the results may be combined with each other to realize the entire semiconductor device. The combined schematic circuit may be verified by a simulation tool. In some example implementations, an adjusting operation may be further performed in consideration of a result of the verification.

The RTL may be used for representing a coding style used in hardware description languages for effectively ensuring that code models may be synthesized in a certain hardware platform such as an FPGA or an ASIC (e.g., code models may be converted into real logic functions). A plurality of hardware description languages may be used for generating RTL modules. For example, the plurality of hardware description languages may include System Verilog, Verilog, VHDL, or the like.

In S1300, the RTL simulation may be performed. The target of the RTL simulation may be the codes itself without timing information, and thus the RTL simulation may be performed quickly.

After that, a gate level design (or gate level design process) of the semiconductor device is performed (operation S1400), and a verification is performed on the semiconductor device on which the gate level design is completed (operation S1500).

The gate level design may represent that a semiconductor device is depicted using basic logic gates, such as AND gates and OR gates, and is described by logical connections and timing information of the logic gates. For example, all signals may be discrete signals and may only have a logical value of zero, one, X and Z (or high-Z).

In S1500, a simulation for verifying static timing matching, dynamic timing matching, or the like, may be performed in consideration of timing-related information, and power-gating netlist (PGNET) simulation for verifying power-related functions, features and/or characteristics may be performed in consideration of power-related information.

Thereafter, a layout level design (or layout level design process) of the semiconductor device is performed (operation S1600), and a verification is performed on the semiconductor device on which the layout level design is completed (operation S1700).

The layout level design may be referred to as a physical design (or physical design process). The layout level design may be performed to implement or realize a logically completed semiconductor device on a silicon substrate. For example, the layout level design may be performed based on the schematic circuit prepared in the high level design or the netlist corresponding thereto. The layout level design may include a routing operation of placing and connecting various standard cells that are provided from a cell library, based on a predetermined design rule.

A cell library for the layout level design may contain information on operation, speed, and power consumption of the standard cells. In some example implementations, the cell library for representing a layout of a circuit having a specific gate level may be defined in a layout design tool. Here, the layout may be prepared to define or describe shapes and sizes of patterns constituting transistors and metal interconnection lines, which will be actually formed on a silicon substrate. For example, layout patterns (e.g., PMOS, NMOS, N-WELL, gate electrodes, and metal interconnection lines thereon) may be suitably disposed to actually form an inverter circuit on a silicon substrate. For this, at least one of inverters defined in the cell library may be selected.

The term “standard cell” may refer to a unit of an integrated circuit in which a size of the layout meets a preset rule or criterion. The standard cell may include an input pin and an output pin and may process a signal received through the input pin to output a signal through the output pin. For example, the standard cell may include a basic cell such as an AND logic gate, an OR logic gate, a NOR logic gate, or an inverter, a complex cell such as an OR/AND/INVERTER (OAI) or an AND/OR/INVERTER (AOI), and a storage element such as a master-slave flip flop or a latch.

In addition, the routing operation may be performed on selected and disposed standard cells. In detail, the routing operation may be performed on the selected and disposed standard cells to connect them to upper interconnection lines. By the routing operation, the standard cells may be electrically connected to each other to meet a design.

Layout design schemes may be classified into a full custom type for manually performing a work according to a work type using a layout editor, an auto place & routing (P & R) type using an auto place/routing tool, and a semi-custom type using all of the above-described types.

In S1700, a verification operation may be performed on the layout to check whether there is a portion violating the given design rule, after the routing operation. In some example implementations, the verification operation may include evaluating verification items, such as a design rule check (DRC), an electrical rule check (ERC), and a layout vs schematic (LVS). The evaluating of the DRC item may be performed to evaluate whether the layout meets the given design rule. The evaluating of the ERC item may be performed to evaluate whether there is an issue of electrical disconnection in the layout. The evaluating of the LVS item may be performed to evaluate whether the layout is prepared to coincide with the gate level netlist.

When each design and each verification are performed, e.g., when S1200 and S1300 are performed, when S1400 and S1500 are performed, and/or when S1600 and S1700 are performed, the method of analyzing the ESD network according to example implementations described with reference to FIGS. 1, 2, 3, 4, 5, 6, 7, 8, 9A, 9B, 9C, 9D, 9E and 9F may be performed.

FIG. 11 is a flowchart illustrating an example of a method of manufacturing a semiconductor device.

Referring to FIG. 11, in a method of manufacturing a semiconductor device according to example implementations, the semiconductor device is designed (operation S2100), and the semiconductor device is fabricated based on a result of designing the semiconductor device (operation S2200). The designing operation in S2100 may be performed based on the method of designing the semiconductor device according to example implementations described with reference to FIG. 10.

In S2200, the semiconductor device may be fabricated or manufactured by a mask, a wafer, a test, an assembly, packaging, and the like. For example, a corrected layout may be generated by performing optical proximity correction on the design layout, and a photo mask may be fabricated or manufactured based on the corrected layout. For example, various types of exposure and etching processes may be repeatedly performed using the photo mask, and patterns corresponding to the layout design may be sequentially formed on a substrate through these processes. Thereafter, the semiconductor device may be obtained in the form of a semiconductor chip through various additional processes.

As will be appreciated by those skilled in the art, the example implementations may be embodied as a system, method, computer program product, and/or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain or store a program for use by or in connection with an instruction execution system, apparatus, or device. For example, the computer readable medium may be a non-transitory computer readable medium.

The example implementations may be applied to design various electronic devices and systems that include the semiconductor devices. For example, the example implementations may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IOT) device, an internet of everything (IoE) device, an e-book reader, a virtual reality (VR) device, an augmented reality (AR) device, a robotic device, a drone, an automotive, etc.

While this specification contains many specific implementation details, these should not be construed as limitations on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

The foregoing is illustrative of example implementations and is not to be construed as limiting thereof. Although some example implementations have been described, those skilled in the art will readily appreciate that many modifications are possible in the example implementations without materially departing from the novel teachings and advantages of the example implementations. Accordingly, all such modifications are intended to be included within the scope of the example implementations as defined in the claims. Therefore, it is to be understood that the foregoing is illustrative of various example implementations and is not to be construed as limited to the specific example implementations disclosed, and that modifications to the disclosed example implementations, as well as other example implementations, are intended to be included within the scope of the appended claims.

1. A method of analyzing an electrostatic discharge (ESD) network, the method comprising:
receiving input data characterizing a semiconductor device, the semiconductor device including an input/output (I/O) pad, an ESD protection circuit, and at least one functional circuit;
calculating, based on the input data, a common resistance of the ESD protection circuit using a plurality of resistances and at least one predetermined equation, the plurality of resistances associated with the I/O pad, the ESD protection circuit, and the at least one functional circuit; and
performing a network analysis on the semiconductor device by excluding the common resistance.

2. The method of claim 1, wherein calculating the common resistance includes:
obtaining a first resistance, a second resistance, and a third resistance, the first resistance and the second resistance associated with the I/O pad, and the third resistance associated with the ESD protection circuit; and
obtaining the common resistance based on the first resistance, the second resistance, and the third resistance.

3. The method of claim 2, wherein
a first value is obtained by adding the first resistance and the second resistance,
a second value is obtained by subtracting the third resistance from the first value, and
the common resistance is obtained by dividing the second value by two.

4. The method of claim 2, wherein
the ESD protection circuit is directly connected to a first node,
a first resistor having the common resistance is directly connected between the I/O pad and the first node, and
the at least one functional circuit is connected to the first node.

5. The method of claim 4, wherein the ESD protection circuit includes:
a first diode and a second resistor connected in series between a power supply voltage and the first node; and
a second diode and a third resistor connected in series between the first node and a ground voltage.

6. The method of claim 5, wherein
the first resistance corresponds to a resistance between the I/O pad and the first diode in the ESD protection circuit,
the second resistance corresponds to a resistance between the I/O pad and the second diode in the ESD protection circuit, and
the third resistance corresponds to a resistance between the first diode and the second diode in the ESD protection circuit.

7. The method of claim 4, wherein the ESD protection circuit includes:
a first diode and a second resistor connected in series between a power supply voltage and a second node;
a second diode and a third resistor connected in series between the second node and a ground voltage; and
a fourth resistor connected between the first node and the second node.

8. The method of claim 7, wherein
the first resistance corresponds to a resistance between the I/O pad and the first diode in the ESD protection circuit or a resistance between the I/O pad and the second diode in the ESD protection circuit,
the second resistance corresponds to a resistance between the I/O pad and the at least one functional circuit, and
the third resistance corresponds to a resistance between the first diode in the ESD protection circuit and the at least one functional circuit or a resistance between the second diode in the ESD protection circuit and the at least one functional circuit.

9. The method of claim 4, wherein the ESD protection circuit includes:
a first diode connected between the first node and a ground voltage.

10. The method of claim 9, wherein:
the first resistance corresponds to a resistance between the I/O pad and the first diode in the ESD protection circuit,
the second resistance corresponds to a resistance between the I/O pad and the at least one functional circuit, and
the third resistance corresponds to a resistance between the first diode in the ESD protection circuit and the at least one functional circuit.

11. The method of claim 9, wherein the first diode includes one single transistor.

12. The method of claim 9, wherein the first diode includes two or more transistors.

13. The method of claim 12, wherein the first diode has a fail-safe structure.

14. The method of claim 4, wherein the ESD protection circuit includes:
a first diode connected between a power supply voltage and the first node.

15. The method of claim 14, wherein
the first resistance corresponds to a resistance between the I/O pad and the first diode in the ESD protection circuit,
the second resistance corresponds to a resistance between the I/O pad and the at least one functional circuit, and
the third resistance corresponds to a resistance between the first diode in the ESD protection circuit and the at least one functional circuit.

16. The method of claim 1, wherein performing the network analysis includes:
removing the common resistance from the semiconductor device;
performing a simulation on the semiconductor device from which the common resistance is removed; and
checking, based on a result of the simulation, whether a predetermined rule is violated.

17. The method of claim 16, wherein performing the network analysis includes
in response to determining that the predetermined rule is violated, modifying at least a portion of the ESD protection circuit.

18. A system of analyzing an electrostatic discharge (ESD) network, the system comprising:
a storage device configured to store information including procedures of a semiconductor device; and
a processor configured to access the storage device, and to execute the procedures to:
receive input data characterizing the semiconductor device, the semiconductor device including an input/output (I/O) pad, an ESD protection circuit, and at least one functional circuit;
calculate, based on the input data, a common resistance of the ESD protection circuit using a plurality of resistances and at least one predetermined equation, the plurality of resistances associated with the I/O pad, the ESD protection circuit, and the at least one functional circuit; and
perform a network analysis on the semiconductor device by excluding the common resistance.

19. The system of claim 18, wherein the semiconductor device includes:
a calculator configured to obtain a first resistance, a second resistance, and a third resistance, and to obtain the common resistance based on the first resistance, the second resistance, and the third resistance, the first resistance and the second resistance associated with the I/O pad, and the third resistance associated with the ESD protection circuit; and
the processor is configured to remove the common resistance from the semiconductor device, to perform a simulation on the semiconductor device from which the common resistance is removed, and to check, based on a result of the simulation, whether a predetermined rule is violated.

20. A method of analyzing an electrostatic discharge (ESD) network, the method comprising:
receiving input data characterizing a semiconductor device, the semiconductor device including an input/output (I/O) pad, an ESD protection circuit, and at least one functional circuit that are connected through a first node;
obtaining a first resistance, a second resistance, and a third resistance associated with the I/O pad, the ESD protection circuit, and the at least one functional circuit;
calculating, based on the input data, a common resistance of the ESD protection circuit using the first resistance, the second resistance, the third resistance, and at least one predetermined equation; and
performing a network analysis on the semiconductor device, wherein performing the network analysis comprises removing the common resistance from the semiconductor device, performing a simulation on the semiconductor device from which the common resistance is removed, and checking, based on a result of the simulation, whether a predetermined rule is violated,
wherein the ESD protection circuit includes:
a first diode and a second resistor connected in series between a power supply voltage and the first node; and
a second diode and a third resistor connected in series between the first node and a ground voltage,
wherein the first resistance corresponds to a resistance between the I/O pad and the first diode in the ESD protection circuit, the second resistance corresponds to a resistance between the I/O pad and the second diode in the ESD protection circuit, and the third resistance corresponds to a resistance between the first diode and the second diode in the ESD protection circuit, and
wherein a first value is obtained by adding the first resistance and the second resistance, a second value is obtained by subtracting the third resistance from the first value, and the common resistance is obtained by dividing the second value by two.

21. (canceled)
